(19) United States
(12) Patent Application Publication
(10) Pub. No.: US 2024/0046177 A1
(43) Pub. Date: Feb. 8, 2024

(54) METHODS AND SYSTEMS FOR USE IN SEED PRODUCTION

(71) Applicant: Monsanto Technology LLC, Saint Louis, MO (US)

(72) Inventors: Jennifer BECKER, Muscatine, IA (US); Scott GRASMAN, Flushing, MI (US); Michael HEWITT, Glen Ellyn, IL (US); Shrikant JARUGUMILLI, Dardenne Prairie, MO (US); Meserret KARACA, Gainesville, FL (US); Jonathan VIGLIONE, Creve Coeur, MO (US)

(21) Appl. No.: 18/231,121

(22) Filed: Aug. 7, 2023

Related U.S. Application Data
(60) Provisional application No. 63/396,172, filed on Aug. 8, 2022.

(51) Int. Cl. G06Q 10/0631; G06Q 50/02

(52) U.S. Cl. CPC G06Q 10/06315; G06Q 50/02

(57) ABSTRACT

Systems and methods for assessing variables associated with seed production are provided. One example computer-implemented method includes accessing, by a computing device, data representative of: a seed offering including multiple different seeds, a capacity of multiple production fields, and probability distributions for yield across the multiple fields and for demand for the multiple different seeds. The method then also includes generating, by the computing device, a production target plan, based on multiple scenarios indicative of the probability distributions, for the multiple different seeds and for the production fields, and planting the multiple production fields consistent with the production target plan.

### CROSS-REFERENCE TO RELATED APPLICATION

This application claims the benefit of, and priority to, U.S. Provisional Patent Application No. 63/396,172, filed Aug. 8, 2022. The entire disclosure of the above application is incorporated herein by reference.

### FIELD

The present disclosure generally relates to methods and systems for use in assessing seed production and seed inventories. More particularly, the present disclosure relates to methods and systems for use in decision management for field production of crops for supply of seeds, based on, for example, scenarios representing unknown conditions relating to the fields, the crops, the supply, etc.

### BACKGROUND

This section provides background information related to the present disclosure which is not necessarily prior art.

In agricultural production, available seed is produced (e.g., harvested, etc.) by suppliers and delivered to growers consistent with demand for the seed. In connection with multiple different seeds (e.g., hybrids, etc.), the suppliers allocate resources to grow the seed consistent with an expected demand for, or business goals associated with, the seeds (e.g., launching new hybrids, phasing out other hybrids, etc.). As such, once produced (e.g., once harvested, etc.), the seeds are passed into the inventories of the suppliers, and then sold to the growers to be planted by the growers consistent with demand and/or the business goals.

### SUMMARY

This section provides a general summary of the disclosure and is not a comprehensive disclosure of its full scope or all of its features.

Example embodiments of the present disclosure generally relate to methods for use in assessing variables associated with seed production (and seed inventories). In one example embodiment, such a method generally includes: accessing, by a computing device, data representative of: a seed offering including multiple different seeds, a capacity of multiple production fields, and probability distributions for yield across the multiple fields and for demand for the multiple different seeds; generating, by the computing device, a production target plan, based on multiple scenarios indicative of the probability distributions, for the multiple different seeds and for the production fields; and planting the multiple production fields consistent with the production target plan.

Example embodiments of the present disclosure also generally relate to systems for use in assessing variables associated with seed production. In one example embodiment, such a system includes a computing device configured to: access data representative of: a seed offering including multiple different seeds, a capacity of multiple production fields, and probability distributions for yield across the multiple fields and for demand for the multiple different seeds; and generate a production target plan, based on multiple scenarios indicative of the probability distributions, for the multiple different seeds and for the production fields. In addition, in some example embodiments, the computing device may further be configured to direct one or more farm implements to plant the multiple production fields consistent with the production target plan. Further, or alternatively, in some example embodiments, the system may include one or more farm implements configured to plant one or more of the multiple production fields consistent with the production target plan.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments, are not all possible implementations, and are not intended to limit the scope of the present disclosure.

FIG. 1 illustrates an example system of the present disclosure configured to assess an agricultural inventory and/or demand for one or more seeds, and to instruct decisions related to production and/or sale of the one or more seeds based on the assessment;

FIG. 2 is a flow diagram of example phases associated with production fields in the system of FIG. 1;

FIG. 3 is a block diagram of an example computing device that may be used in the system of FIG. 1; and

FIG. 4 illustrates a flow diagram of an example method, which may be used in (or implemented in) the system of FIG. 1, for assessing an agricultural inventory and/or demand for one or more seeds and then instructing decisions related to production and/or sale of the one or more seeds based on the assessment.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

In seed production, decisions related to populations of different varieties, hybrids, etc. of seeds (or plants or crops grown from the seeds in different production fields, for example) are made at or before planting, when certain relevant data relating thereto is unavailable. For example, a demand in following seasons for specific seeds is unknown, as well as a volume of carry-in inventories of different seeds. In the context of hundreds of different varieties of seeds or hybrids of seeds, especially when planting more of one variety or hybrid means planting less of another variety or hybrid, the complexity of planting decisions is problematic for seed producers. Beyond that, when an inventory of some seeds is available, and certain varieties or hybrids of seeds can act as substitutes for other varieties or hybrids, decisions related to satisfying the current and/or future demand for the different varieties or hybrids of seeds is also problematic for seed producers and/or suppliers.

Uniquely, the systems and methods herein provide for (and implement) modeling as a basis to make decisions about planting and/or decisions about fulfilling agricultural demand for seeds (e.g., different varieties of seeds, different hybrids of seeds, etc.), whereby an impact (e.g., a negative impact, a detrimental impact, etc.) on such decisions associated with unavailable information is minimized, limited, etc. (broadly, taken into account, etc.).

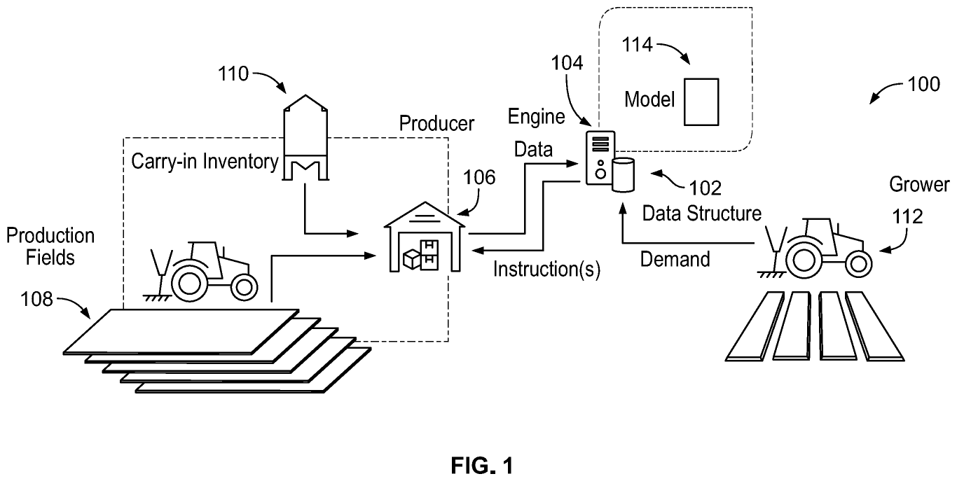

FIG. 1 illustrates an example system 100 in which one or more aspects of the present disclosure may be implemented. Although the system 100 is presented in one arrangement, other embodiments may include the parts of the system 100 (or additional parts) arranged otherwise depending on, for example, number and size of production fields; number of different varieties of seeds; number of different hybrids of seeds; number of different crops; availability of carry-in inventories and/or storage inventories; etc.

The system 100 generally includes a data structure 102 in communication with an inventory engine 104 (or inventory engine computing device). The data structure 102 includes a variety of different information related to the production of seeds by a producer 106 in the system 100. It should be appreciated that the producer 106 may include any seed production entity, which, generally, produces seeds and then sells the seeds to one or more growers (e.g., grower 112, etc.) or other entities, which use the seeds.

In this example embodiment, as shown in FIG. 1, the producer 106 includes numerous production fields 108. While five production fields 108 are illustrated in FIG. 1, it should be appreciated that the producer 106 may include (or may be associated with) tens, hundreds, thousands, or tens of thousands of fields, or more or less, in various embodiments, depending on, for example, a size of the particular producer 106 associated with the production fields 108, etc. Data indicative of the production fields 108 is also included in the data structure 102. The data may include, without limitation, capacity (e.g., acres, etc.) (per production field, or group of production fields, etc.), location, centroid, region (e.g., geographic region, etc.), boundaries, soil type and/or condition(s), crop history, current crops, etc. of the production fields 108, and/or other suitable data related to the production fields 108 and/or an ability of the production fields 108 to produce inventory, etc.

The data structure 102 also includes seed offerings for (and/or provided by) the producer 106 along with data related to the seed offerings. The seed offerings may include, for example, corn (or maize), wheat, beans (e.g., soybeans, etc.), peppers, tomatoes, tobacco, eggplant, rice, rye, sorghum, sunflower, potatoes, cotton, sweet potato, coffee, coconut, pineapple, citrus trees, prunes, cocoa, banana, avocado, fig, guava, mango, olive, papaya, cashew, almond, sugar beets, sugarcane, oats, barley, vegetables, or other suitable crop or products or combinations thereof, etc. It should be appreciated therefore that the seed offerings may include different varieties of seeds (and/or corresponding crops), different hybrids of seeds, seeds for different crops, etc. The data in the data structure 102, which relates to the seed offerings, may include, without limitation, plant types, variety identifiers, characteristics (e.g., stalk strength, root strength, root stretch, etc.), disease resistance data, price, cost, packaging details, or other suitable data associated with the seed offering. Between the different seeds/plants and the different varieties and/or hybrids of seeds, the system 100 may include dozens or hundreds (or more or less) (e.g., 30, 100, 300, 500, 1000, etc.) different seeds (e.g., different varieties of seeds, different hybrids, seeds for different crops, etc.) in the seed offerings for the producer 106 (and, generally, produced in the production fields 108, etc.).

In addition, the data structure 102 includes costing data for the seeds, including, for example, profit margins, cost of left-over inventory, planting costs (e.g., cost per acre per hybrid, etc.), capital costs, seed yields (e.g., as modeled by and/or as represented by probability distributions, etc.), etc. The data structure 102 may additionally include data relating to the producer 106, for example, a name, a production history, a yield history (for the producer 106 in general, for each of the different varieties of seeds provided by the producer 106, for each of the different hybrids provided by the producer 106, for the seeds provided by the producer for different crops, etc.), a sales history, etc.

Further, the data structure 102 includes one or more indicators for one or more of the seeds included in the seed offering, which indicate which seeds are substitutes for which seeds. For example, a first corn hybrid h₁ may be a substitute for a second corn hybrid h₂, whereby the first corn hybrid may be used to fulfill a demand for the second corn hybrid (e.g., under certain conditions, etc.). Seeds that are substitutes may be understood then to be included in a same agronomic grouping (e.g., as represented by an agronomic listing, table, etc.), for example, with regard to supply, production, etc. The data structure 102 may then include indicators assigning various seeds to the different groupings (or the seeds may be organized within the data structure 102 into the groupings), when the seeds are substitutes. In connection therewith, the producer 106 may implement one or more demand-shaping actions or activities to potentially direct growers to certain substitutes. In general, demand shaping includes any action used to influence customer demand in a way that reduces demand for supply-limited varieties and increases demand for substitute varieties. These activities may include pricing adjustments, discounting, or targeted product recommendations by agronomists or salespeople.

With continued reference to FIG. 1, the producer 106 may have, or may have access to, a carry-in inventory 110, which includes seed inventory from a prior interval (e.g., season, etc.), which is available to fulfill demand in a current or later interval (broadly, another interval). The carry-in inventory 110 is stored in one or more containers, such as, for example, a warehouse, silo, etc., and is generally available in a manner consistent with production seed from the production fields 108. It should be appreciated that, in this example, the carry-in inventory 110 may include seeds from the prior interval that were unsold, and also returns of seeds from growers (e.g., the grower 112, etc.) who had previously purchased the seeds (e.g., pursuant to one or more agreements, conditions, etc.), etc. but subsequently returned the seeds (e.g., because they were not planted for one or more reasons, etc.). The returned seeds from the prior interval may be subject to one or more quality checks prior to being included in (or identified as part of) the carry-in inventory 110 (and thereby made available for resale, etc.).

In connection therewith, the data structure 108 includes historical data related to the carry-in inventory 110, in general and/or per specific seed variety therein and/or per specific crop type therein, etc. The data structure 102 may include, specifically, percentages (and/or amounts) of seeds in the carry-in inventory 110 that meet quality standards for resale, per variety of seed, for specific intervals.

As indicated above, the producer 106 interacts with various growers, including the grower 112, which purchase seeds. The growers may plant seeds relating to one or more different crops, one or more different varieties of the seeds (used to thereby produce the crops), and/or one or more different hybrids for a variety of different objectives (e.g., yield, feed, profit, etc.). The growers are also generally associated with various different types of fields (e.g., with differing soil types and/or composition, locations, disease conditions, weather, etc.), whereby the growers may desire different, or specific, varieties of seeds, hybrids of seeds, etc. to plant in their fields. For example, a grower in Missouri may request a corn variety that is particularly suited for heat resistance, insect resistance, and drought tolerance, while a different grower in Michigan may request a corn variety with a relative maturity of no more than 90 days. More generally, the growers provide a demand for particular seeds and/or seeds of particular varieties and/or hybrids, which is generally expressed to the producer 106 in connection with such seed requests/purchases that must be accounted for in production and ultimate supply.

In connection with the demand, the data structure 102 includes historical data related to demand, in general and/or per specific crop and/or seed variety, etc. As such, the data structure 102 may also include, specifically, probability distributions indicative of the probability of specific demands for specific varieties and/or hybrids of seeds for specific intervals (e.g., for different crops, etc.) (e.g., the probability of scenarios occurring, etc.).

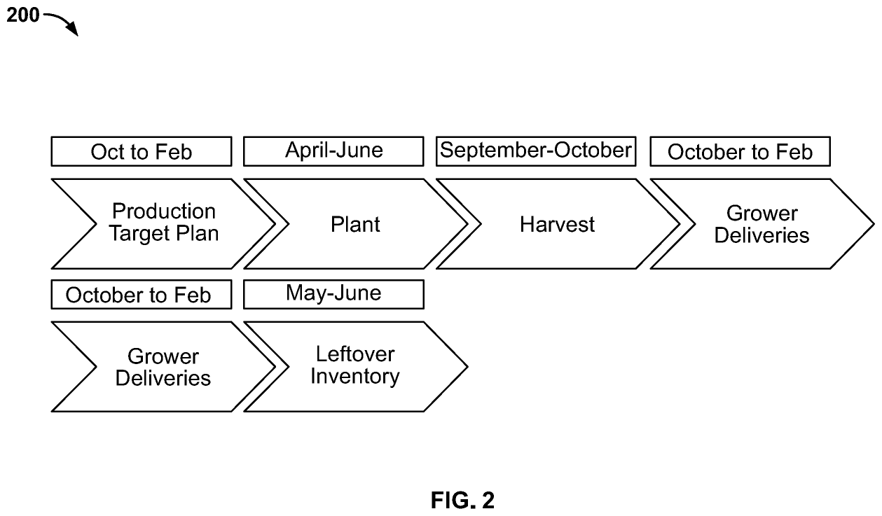

It should be appreciated that the timing of the data above being available to (and appended to or included in) the data structure 102 is variable, as it pertains to supply chain planning and demand fulfillment by the producer 106. In particular, for example, FIG. 2 illustrates an example flow diagram 200, which illustrates an example flow of data and/or decisions related to the system 100 in the context of time (for the producer 106 in connection with the production fields 108 and the carry-in inventory 110). It should, of course, be appreciated that the time intervals and/or timing illustrated in FIG. 2 are example and should not be understood to limit the timing of data flow, intervals, seasons, etc., of the present disclosure.

As shown in FIG. 2, in this example flow diagram 200, a production target plan is developed in October to February of a first year and is then implemented (e.g., planted, etc.) in the following April to June time interval (during which the production targets for each variety of seed may then be known). Crops resulting from the planted seeds, then, are harvested in September to October and the resulting seeds from the harvest are delivered to growers (e.g., the grower 112, etc.) in October to February for planting the following year. The phases of the production field 108, and seeds resulting therefrom, generally in this example, extend from October/February in one year to October/February of the following year. As such, as described, again, the production target plan is decided in the October/February interval of the first year, and the production fields 108 are planted in the following April/June interval with harvest in the September/October interval. And, seed delivery occurs a year later in the following October/February interval. Thus, as shown in this example, the deliveries of seeds by growers of the prior year's harvest overlap the production target plan decisions of the current year. As a result, throughout the timeline illustrated in the flow diagram 200, there is uncertainty in performance of a set of planned production targets along dimensions such as, for example, profitability and ability to meet customer demands, etc.

Again, it should be appreciated that the flow diagram 200 is example in nature and may vary, for example, depending on region, hemisphere, etc. What's more, it should be appreciated that the time intervals illustrated in the flow diagram 200 are not absolute and may vary, for example, by one or more days, one or more weeks, one or months, etc. depending, for example, on location, crops, seed varieties, etc.

At the time when the production target plan is decided (e.g., in the example flow 200, etc.), the engine 104, which is configured to generate the production target plan (as described below), lacks specific knowledge of the demand from the growers for deliveries in the following October/February interval, the yield from the harvest in the following September/October interval and also the leftover inventory (or carry-in inventory 110). In other words, there is a time gap (e.g., a significate time gap, etc.) from when the production target plan is generated to when demand from the growers and deliveries are known/available. As such, in this example embodiment, the data structure 102 holds (or includes) historical data from which probability distributions of those quantities can be derived.

In view of the above, the engine 104 is configured to provide insight into the allocation of the production fields 108 for production of seeds to satisfy a given demand in a specific interval (e.g., an unknown demand that is between about 18 months and about 24 months later in time, etc.), in combination with (or accounting for) the carry-in inventory 110, and then, also, to utilize the production inventory of seeds to satisfy the demand. In connection therewith, for example, the engine 104 is configured to account for the production harvest form the production fields 108, the carry-in inventory 110, and then demand of growers across dozens or hundreds of seeds and/or varieties and/or hybrids to develop and implement the necessary allocation.

Specifically, in this example embodiment, the engine 104 is configured as a stochastic programming model 114, as shown in FIG. 1. The model 114 accounts for the variables of the system 100 and constraints indicative of the system 100 (and, potentially, business objectives of the producer 106, production and/or sales rules and/or requirements, etc.), to generate instructions for allocation for planting and/or demand. In doing so, the model 114 (as implemented by or as the engine 104, etc.) is associated with a planting instruction for each of the production fields 108 (e.g., compile a production target plan for each field of the production fields 108, for combinations of fields in the production fields 108, for all of the production fields 108, etc.) and also with fulfillment of demand from the available production inventory and carry-in inventory.

From the above, it should be appreciated that the following inputs may be provided to the model 114/engine 104: statistical distributions describing incomplete information regarding seed variety attributes for each of the seed varieties (e.g., a statistical distribution for sellable inventory, a statistical distribution for production yield, and a statistical distribution for customer demand, etc.); production targets (e.g., an amount to be planted, etc.); economic factors (e.g., per unit margins achieved when each variety is sold to meet demand for that hybrid, per unit costs incurred when inventory of each variety is left over at the end of a selling season, etc.); and a substitution matrix (e.g., a listing of potential substitutions (e.g., opportunities to sell inventory of one variety to meet demand of another variety, etc.), etc.).

The engine 104 is configured to define various scenarios, co, for example, sets of outcomes, etc., for the producer 106, which collectively represent yield distributions (e.g., with regard to the production fields 108, etc.), carry-in distributions (e.g., with regard to the carry-in inventory 110, etc.), and demand distributions across numerous varieties and/or hybrids of seeds. As such, for each variety, the distributions generally indicate an amount of sellable carry-in, production yields, and customer net demands. In the illustrated embodiment, the scenarios are each generated randomly (however, this is not required in all embodiments).

It should be appreciated that the distributions are defined by multiple moments, including an expected value, a variance, a skewness and a kurtosis, in this example embodiment. The moments of the different distributions are an input to the engine 104, whereby the engine 104 is configured to generate a specific number of scenarios (i.e., also used as or considered an input), whereby the scenarios are generated along with statistics representative of the ability of the scenarios to accurately represent the underlying probability distributions. See, Hoyland, K., Kaut, M. & Wallace, S. W. “A Heuristic for Moment-Matching Scenario Generation,” Computational Optimization and Applications 24, 169-185 (2003).

In addition, the engine 104 is configured to determine a total amount of sellable inventory available for each variety of seed, for example, based on amounts of sellable carry-in and production yields as described by a given scenario, as well as production targets. Here, knowing the amount of sellable carry-in for each variety, its production target, and its production yield, enables determining a total amount of sellable inventory for each variety in the given scenario. Further, the engine 104 is configured to determine (for each variety) how much demand for each variety may be met with sellable inventory of that same hybrid (e.g., referred to as primary supply, etc.), how much demand for each variety is not met with primary supply (e.g., referred to as lost net sales from primary, etc.), and how much sellable inventory is left after meeting its demand (e.g., referred to as left over sellable inventory, etc.). Then, the engine 104 is configured to heuristically solve an optimization problem that seeks to allocate left over sellable inventories to lost net sales from primary to maximize profit. This allocation is done in observance of potential substitutions provided to the engine 104 and uses profit calculations driven by profit margins achieved when substitution occurs. The engine 104 also determines the amount of sellable inventory of each variety that is left over after both primary fulfillment and substitution.

From the above, then, the engine is configured to determine (for the given scenario) total profit (e.g., primary profits+substitution profits−left over inventory costs, etc.), primary fill rate (e.g., average percentage of hybrid demand met via primary supply, etc.), and fill rate (e.g., average percentage of variety demand met via either primary supply or substitution, etc.). This may be repeated, as desired, for each scenario. And, for each repetition, one or more performance indicators may be recorded and at termination the engine 104 may report an average of the performance indicators over all repetitions. The engine 104 may further report an average substitution amount over all repetitions for each possible substitution.

That said, in order, then, to assess specific decisions of allocation and demand fulfillment in different scenarios, the engine 104 defines the system 100 by various constraints, which are provided below, with reference to a set of seed varieties, or in this example, hybrids, H. That said, it should be appreciated that the configuration of the engine 104, herein, is not limited to specific hybrids, or any hybrids, as other seed varieties may be the subject of the allocation(s) herein.

Table 1 provides certain data elements that may be used in the constraints below, which relate to the given scenario, ω, and/or hybrid, h (broadly, variety). The data elements associated with a hybrid h, for example, as shown in Table 1, are accessed from the data structure 102.

TABLE 1

| | |
|---|---|
| Data Element | Description |

First Stage

| | |
|---|---|
| uₕ, ∀h ϵ H | Capacity for hybrid h |
| mₕ, ∀h ϵ H | Minimum acreage allocation for hybrid h |
| lₕ, ∀h ϵ H | Lifecycle of hybrid h |
| l_{φ} | Lower bound on expected fill rate |

Second Stage, Scenario-Independent

| | |
|---|---|
| oₕ, ∀h ϵ H | Cost per unit of left over inventory of hybrid |
| | h |
| p_{hh′}, ∀(h, h′) ϵ S | Per-unit profit achieved when hybrid h sold to |
| | meet demand of hybrid h′ |
| rpln_{hh′}, ∀(h, h′) ϵ S | Replant percentage of hybrid h when sold to |
| | meet demand for hybrid h′ |
| adj-rtrnₕ, ∀h ϵ H | Demand shaped return percentage for hybrid |
| | h |
| rtrnₕ, ∀h ϵ H | Return percentage for hybrid h |
| M_{adj} | Maximum number of hybrids for which |
| | demand shaping can be performed |
| vₗ, l ϵ L | Number of shortage buckets for hybrids in |
| | lifecycle l |
| u₁, . . . , uᵥ_{ₗ} | Upper limits (as a percentage) of lost gross |
| | sales that can be met via substitution for |
| | hybrids in lifecycle l |
| eₗ^{j}, j = 1, . . . , vₗ, l ϵ L | Percentage of shortage in bucket j that is |
| | eligible for substitution for a seed variety in |
| | lifecycle l |
| σ_{hh′} ϵ [0, 1], ∀(h, h′) ϵ S | Percentage of eligible shortage of seed variety |
| | h′ that can be met via supply of seed variety h |

Second Stage, Scenario-Dependent, ∀ω ϵ Ω

| | |
|---|---|
| π_{ω}, ∀_{ω} ϵ Ω | Probability of scenario ω occurring |
| yₕ^{ω}, ∀h ϵ H, ω ϵ Ω | Yield of hybrid h |
| Iₕ^{0ω}, ∀h ϵ H, ω ϵ Ω | Amount of sellable carry-in inventory of |
| | hybrid h |
| dₕₙₑₜ^{ω}, ∀h ϵ H, ω ϵ Ω | Net demand for hybrid h |
| d_{hgross}^{ω}, ∀h ϵ H, ω ϵ Ω | Gross demand for hybrid h |

In addition to the data elements in Table 1, the engine 104 may further be configured to determine certain decision variables, as provided, for example, in Table 2 (e.g., as decisions in a plan prescribed by the engine 104, etc.).

TABLE 2

| | |
|---|---|
| Decision Variable | Description |

First Stage

| | |
|---|---|
| pₕ ϵ {0, 1}, ∀h ϵ H | Indicator of whether hybrid h is planted |
| aₕ ϵ R₊, ∀h ϵ H | How many acres to allocate to hybrid h |
| ϕ ϵ [0, 1] | Expected fill rate over all hybrids |

Second Stage, Scenario-Dependent, ∀ω ϵ Ω

| | |
|---|---|
| ϕ^{ω} ∀ω ϵ Ω | Average fill rate over all hybrids in scenario |
| | ω |
| Iₕ^{ω} ϵ R₊, ∀h ϵ H, ω ϵ Ω | Amount of inventory of hybrid h |
| Iₕ^{ω}∀h ϵ H, ω ϵ Ω | Amount of left-over inventory of hybrid h |
| x_{hh′net}^{ω} ϵ R₊, | Amount of hybrid h used to meet net demand |
| ∀(h, h′) ϵ S, ω ϵ Ω | for hybrid h′ |
| x_{hh′gross}^{ω} ϵ R₊, | Amount of hybrid h used to meet gross |
| ∀(h, h′) ϵ S, ω ϵ Ω | demand for hybrid h′ |
| arplnₕₕ^{ω}, ϵ R₊, | Amount replanted of hybrid h when used to |
| ∀(h, h′) ϵ S, ω ϵ Ω | meet demand of hybrid h′ |
| artrnₕₕ^{ω}, ϵ R₊, | Amount returned of hybrid h when used to |
| ∀(h, h′) ϵ S, ω ϵ Ω | meet demand of hybrid h′ |
| adjₕ^{ω} ϵ {0, 1}, ∀h ϵ H, | Indicator of whether returns adjustment is |
| ω ϵ Ω | applied to hybrid h in scenario ω |
| zₕₙₑₜ^{ω} ϵ R₊, ∀h ϵ H, | Amount of net demand of hybrid h not met by |
| ω ϵ Ω | primary supply |
| z_{hgross}^{ω} ϵ R₊, ∀h ϵ H, | Amount of gross demand of hybrid h not met |
| ω ϵ Ω | by primary supply |
| sₕ^{ω} ϵ {0, 1}, ∀h ϵ H | Indicator of whether demand for hybrid h can |
| | be met by supply of another hybrid |
| ηₕ^{ω} ϵ {0, 1}, ∀h ϵ H, | Indicator of whether inventory of hybrid h can |
| ω ϵ Ω | be used to meet demand of another hybrid |
| b_{hgross}^{ωj} ϵ R₊, ∀h ϵ H, | Amount in each bucket of eligible shortage |
| ω ϵ Ω, j = 1, . . . , vₗ | for hybrid h that may be eligible for |
| | substitution |
| es_{hgross} ϵ R₊, ∀h ϵ H, | Total amount of eligible shortage for hybrid h |
| ω ϵ Ω | |

Based on the above, the engine 104 is configured to associate one or more constraints to the allocation of the production fields 108 and then the production inventory (and carry-in inventory 110). For example, the engine 104 is configured to define constraints to account for capacity of the production fields 108, as provided, for example, in Equations (1) and (2).

aₕ≤uₕpₕ∀h∈H, (1)

aₕ≥mₕpₕ∀h∈H, (2)

As shown, the constraint of Equation (1) limits an amount, a, of the hybrid, h, that can be allocated, when a positive amount of hybrid h is allocated, which is indicated by p. The constraint of Equation (2) ensures that when p indicates that a positive amount of hybrid h is to be allocated, at least a minimum amount, m, is allocated. The engine 104 is configured to also determine (or compute) the inventory, or production inventory (or sellable inventory) of available hybrids, per hybrid, h, for a given scenario, ω, as provided in Equation (3).

Iₕ^{ω}=Iₕ^{0ω}+yₕ^{ω}aₕ, ∀h∈H, ω∈Ω, (3)

In Equation (3), the first term is the beginning inventory, or carry-in inventory (e.g., carry-in inventory 110, etc.), of the hybrid h, and the second term is the total harvested amount of hybrid h across the production fields 108 (based on the production yield of the hybrid seed h, yₕ^{w}, and the production target aₕ).

The constraint of Equation (4) limits the gross demand of the hybrid h met by the demand for that hybrid.

Σ_{h′∈H}x_{h′hgross}^{ω}≤d_{hgross}^{ω}∀h∈H, ω∈Ω, (4)

The constraint of Equation (5) limits the total amount of hybrid gross demand met by hybrid h by the amount of inventory available of h.

Σ_{h′∈H}x_{hh′gross}^{ω}≤Iₕ^{ω}∀h∈H, ω∈Ω, (5)

The constraint of Equation (6) determines the amount of hybrid h that is replanted when used to fulfill the demand for hybrid h′.

arpln_{hh′}^{ω}=rpln_{hh′gross}^{ω}, ∀h, h′∈H, ω∈Ω, (6)

The constraints of Equations (7) and (8) determine the amount of hybrid h that is returned when used to fulfill demand for hybrid h′. With the understanding that adj−rtrn_{h′}≤rtrn_{h′}. Equation (7) determines a lower limit on the returns that occur due to demand-shaping, and Equation (8) provides for the non-demand-shaped returns amount to be used when demand-shaping is not applied.

artrn_{hh′}^{ω}≥adj−rtrn_{h′}x_{hh′gross}^{ω}, ∀h, h′∈H, ω∈Ω, (7)

artrn_{hh′}^{ω}≥rtrn_{h′}x_{hh′gross}^{ω}−adjₕ^{ω}d_{hgross}^{ω}, ∀h, h′∈H, ω∈Ω, (8)

The constraint of Equation (9) limits the number of hybrids to which returns adjustment is applied to at most the given parameter, M_{adj}.

Σ_{h∈H}adjₕ^{ω}≤M_{adj}∀ω∈Ω, (9)

The constraint of Equation (10) determines the net sales of the hybrid h′ to meet the demand of the hybrid h.

x_{h′hnet}^{ω}=x_{h′hgross}^{ω}−artrn_{h′h}^{ω}−arpln_{h′h}^{ω}∀h, h′ ∈H, ω∈Ω, (10)

The constraint of Equation (11) determines how much net demand of the hybrid h is not met by primary supply. Here, primary supply indicates, for example, that hybrid h is sold to meet demand for hybrid h. As such, Equation (11) then determines how much net demand of hybrid h is not met by primary supply and instead potentially met, for example, by substitution (e.g., by another hybrid, etc.), etc.

xₕₕₙₑₜ^{ω}+zₕₙₑₜ^{ω}=dₕₙₑₜ^{ω}∀h∈H, ω∈Ω, (11)

The constraint of Equation (12) determines the lost gross demand for the hybrid h in terms of the primary supply, based on lost net demand for that hybrid h (taking into account net demand, percent of demand representing replants, and percent of demand representing returns).

$${z}_{hgross}^{ω} = \frac{{z}_{h n e t}^{ω}}{1 - {rpln}_{h} - {rtrn}_{h}} ∀ h ∈ H , ω ∈ Ω , \qquad ( 12 )$$

The constraint of Equation (13) determines lost net demand of the hybrid h after substitution is considered.

zₕₙₑₜ^{subω}=zₕₙₑₜ^{ω}−Σ_{h′∈H}x_{h′hnet}^{ω}∀h∈H,ω∈Ω, (13)

Together, the constraints of Equations (14) and (15) may ensure that the demand for hybrid h is first met by primary supply. Conversely, the constraints of Equations (16) and (17) may ensure that inventory of hybrid h is first used to meet the demand for hybrid h. They do so, for example, by ensuring that the gross sales of hybrid h are at least as great as the lesser of the inventory and gross demand of that hybrid.

x_{hhgross}^{ω}≥Iₕ^{ω}−(1−sₕ^{ω})Mₕ^{ω}∀h∈H, ω∈Ω, (14)

x_{h′hgross}^{ω}≤σ_{h′h}^{ω}d_{hgross}^{ω}sₕ^{ω}∀(h′, h) ∈S, ω∈Ω, (15)

x_{hhgross}^{ω}≥d_{hgross}^{ω}η_{hω}∀h∈H, ω∈Ω, (16)

x_{hhgross}^{ω}≥Iₕ^{ω}−Mₕ^{ω}ηₕ^{ω}∀h∈H, ω∈Ω, (17)

More particularly, and as previously described, substitutions generally represent one (or more) seed variety that potentially meets the gross demand of another (e.g., where seed variety A may be sold to meet gross demand for seed variety B in the discussion below, etc.). In the context of the system 100 above (and method 300), then, it should be appreciated that the engine 104 (via the model 114, for example, described herein) may take into account one or more rules with respect to how much substitution can occur and when it can occur (e.g., as accounted for in Equations (14)-(17) and/or other constraints/equations, etc.). Such rules may relate to how substitution contributes to profits, when substitution can occur, and how much substitution can occur.

With regard to how substitution contributes to profits (and rules relating thereto), for example, it should be appreciated that the profit margin when seed variety A is sold to meet gross demand of seed variety B may be different than when seed variety A is sold to meet gross demand of seed variety A or when seed variety B is sold to meet gross demand of seed variety B (e.g., filling demand based on substitutions may have different profit margins than filling demand based on primary supply, etc.). This may be because the sales price when seed variety A substitutes for seed variety B is different than when seed variety A is sold to meet demand for seed variety A or when seed variety B is sold to meet demand for seed variety B. Further, the cost-of-goods-sold for seed variety A may be different from that of seed variety B (and independent of the seed variety it is sold for).

With regard to when substitutions can occur (and rules relating thereto), from a demand fulfillment perspective, substitution may only be allowed to occur when there is gross demand for a seed variety for which there is insufficient primary supply. From a supply perspective, a seed variety may only serve as a substitute with inventory that remains after meeting its own gross demand. In other words, substitution may not be allowed to occur because economics indicate that substituting, for example, seed variety A for seed variety B, is more profitable than selling seed variety A for demand/request for seed variety A or selling seed variety B for demand/request for seed variety B (or both). As such, for example, the only gross demand for seed variety B that may be met via substitution may be that which is left over after all its primary supply is used to meet gross demand for seed variety B. And, the only inventory of seed variety A that may be used to meet gross demand for seed variety B may be that which is left over after all the gross demand of seed variety A has been met.

With regard to how much substitution can occur (and rules relating thereto), not all gross demand for a seed variety for which there is insufficient primary supply may be satisfied via substitution. To this point, gross demand for a seed variety that is not met by primary supply may be treated herein (or referred to, etc.) as shortage from primary supply. More specifically, for example, the shortage from primary supply of seed variety B that can be meet by supply of seed variety A may depend on two factors. The first factor is the amount of shortage from primary supply that can be met via substitution, referred to herein as eligible shortage. This amount is independent of the substituting seed variety under consideration. The second factor then is the amount of eligible shortage that can be met with supply of seed variety A.

In connection with the determination of eligible shortage above, a premise may be made (e.g., by the engine 104 via the model 114, for example, herein, etc.) that the more shortage from primary supply there is, the harder it is for sales operations to meet customer demands via substitution. In addition, the ability of sales to do so may depend on where a seed variety is in its life cycle. More specifically, the shortage from primary supply may be divided, allocated, etc. into groups (or categories or buckets) based on its percentage of gross demand. In one example, the groups may include (1) a first x % (e.g., the first 20%, etc.), (2) a second y % (e.g., the second 30%), and (3) a last z % (e.g., the last 50%, etc.). A certain percentage of eligible supply in each group may then be presumed as eligible for substitution. These percentages depend on where the seed variety is in its lifecycle. It should be appreciated that any number of desired groups may be used within the scope of the present disclosure (e.g., three as illustrated herein, less than three, more than three, etc.).

The percentages of the three groups may also generally decline over time/lifecycle for a seed. For example, 100% of the first 20% of shortage from primary supply may be eligible for substitution regardless of where a seed variety is in its lifecycle. However, for a seed variety that is newly launched, 60% of the second 30% may be eligible for substitution, while for a seed variety that is a mature product, 80% of the second 30% may be eligible. The eligible shortage for a seed variety may then be the total eligible shortage across the three groups. As such, in this example, seed variety B may have 5,000 units of shortage in the first group, 2,000 units of shortage in the second group, and none in the third group. If seed variety B is a newly launched seed variety, then the eligible shortage would be: 5,000*100%+2,000*60%=6,200 units. If seed variety B is a mature seed variety, then the eligible shortage would be 5,000*100%+2,000*80%=6,600 units.

That said, regarding the second factor (with respect to how much substitution can occur), the engine 104 (via the model 114, for example, described herein) may presume that potential substitutions have been determined a priori. For example, the engine 104 (via the model 114, for example, herein) may presumes that both seed variety A and seed variety C have been identified as potential substitutes for seed variety B. In addition, for each potential substitute, the engine 104 (via the model 114, for example, herein) may presume a value that indicates the percentage of eligible shortage of seed variety B that can be met via inventory of the potential substitute seed variety. As such, in the above example, where seed variety B is a mature seed variety, there may be 6,600 units of eligible shortage. Further, if the substitute percentage of seed variety A for seed variety B is 96%, the maximum amount of gross demand of seed variety B that can be met via inventory of seed variety A then may be 6,336 (e.g., 6,600*96%, etc.). And, if the substitute percentage of seed variety C for seed variety B is 90%, then the maximum amount of gross demand of seed variety B that can be met via inventory of seed variety C may be 5,940 (e.g., 6,600*90%, etc.).

With that said, as indicated above (see, e.g., Table 2 and Equation (12)), z_{hgross}^{ω} gross represents the amount of gross demand for seed variety h that is not met by inventory of seed variety h in scenario ω. In other words, z_{hgross}^{ω} is the shortage from primary supply for seed variety h. This shortage, then, is partitioned into groups (as generally described above), for example, based in part on percentages of gross demand. In doing so, the engine 104 (via the model 114, for example) may presume the a priori definition of values v₁, v₂, and v₃ that represent the upper limit (as a percentage) on each group. The quantities b_{hgloss}^{ωj} ross for each group j=1, 2, 3, then, represent the amount in each of the group and are determined via Equations (18)-(21). The constraints associated with Equations (18) and (19) limit the quantities b_{hgross}^{ωj} by percentages of gross demand for that hybrid. The constraints associated with Equations (20) and (21) limit those same quantities by the shortage, z_{hgross}^{ω}, of that hybrid.

b_{hgross}^{ω1}≤v₁d_{hgross}^{ω}∀h∈H,ω∈Ω, (18)

b_{hgross}^{ωj}≤vⱼd_{hgross}^{ω}−vⱼ₋₁d_{hgross}^{ω}∀h∈H,ω∈Ω,j=2, . . . , 3, (19)

b_{hgross}^{ω1}≤z_{hgross}^{ω}∀h∈H,ω∈Ω, (20)

b_{hgross}^{ωj}≤z_{hgross}^{ω}−Σ_{j′=}^{j-1}b_{hgross}^{ωj′}∀h ∈H, ω∈Ω, j=2, . . . , 3, (21)

In addition, the engine 104 (via the model 114, for example, herein) may presume the a priori identification of percentages of shortage in each group that is eligible for substitution and that these percentages depend in part on where a seed variety is in its lifecycle. Thus, lₕ may indicate the lifecycle of seed variety h and, and ∈ₗ^{j}, for each group j=1, 2, 3, may represent the percentage of shortage in group j that is eligible for substitution for a seed variety in lifecycle l. Here, lₕ and ∈ₗ^{j}, may be data elements provided to the model 114 (and/or engine 104).

Further, es_{hgross}^{ω} is defined to represent the amount of eligible shortage of seed variety h in scenario ω. In connection therewith, es_{hgross}^{ω} is computed as in Equation (22).

es_{hgross}^{ω}=∈ₗ_{ₕ}¹b_{hgross}^{ω1}+∈ₗ_{ₕ}²b_{hgross}^{ω2}+∈ₗ_{ₕ}³b_{hgross}^{ω3} (22)

The engine 104 (via the model 114, for example, herein) may also presume the a priori identification of percentages of eligible shortage of a seed variety that can be met by each of its substitutes. More precisely, the quantity σ_{h′h} represents the percentage of eligible shortage of seed variety h that can be met via supply of seed variety h′. Thus, the maximum amount of gross demand of h that can be met via supply of h′ is σ_{h′h}es_{hgross}^{ω}. And, in connection therewith, the engine 104 (via the model 114, for example, herein) may then implement the constraint of Equation (23), which indicates that the amount of seed variety h′ that is sold to meet demand of seed variety h can not exceed the maximum gross demand σ_{h′h}es_{hgross}^{ω}, subject to the constraint of Equation (24), which indicates that the total gross demand of seed variety h met by substitution does not exceed the eligible shortage.

x_{h′hgross}^{ω}≤σ_{h′h}es_{hgross}^{ω} (23)

Σ_{h′≠h}x_{h′hgross}^{ω}≤es_{hgross}^{ω} (24)

Further in the system, the constraint of Equation (25) determines the amount of hybrid h left over at the end of the selling interval.

lₕ^{ω}=Iₕ^{ω}−x_{hhgross}^{ω}−Σ_{h′∈H:h′≠h}x_{hh′gross}^{ω}+artrnₕₕ^{ω}+Σ_{h′∈H:h′≠h}artrn_{hh′}^{ω}∀h∈H, ω∈Ω, (25)

The constraint of Equation (26) provides the average fill rate with respect to the primary supply over all hybrids in the scenario w.

$${ϕ}^{ω} = {\sum }_{h ∈ H} \frac{\frac{{x}_{h h n e t}^{ω}}{{d}_{h n e t}^{ω}}}{\vert H \vert} \text{∀ω} ∈ Ω , \qquad ( 26 )$$

The constraint of Equation (27) provides the expected fill rate, calculated as the percentage of hybrid demand that is met, over all hybrids and scenarios.

ϕ=Σ_{ω∈Ω}π_{ω}ϕ^{ω}, (27)

The constraint of Equation (28) ensures that the expected fill rate over all hybrids and scenarios satisfies a defined threshold.

Ø≥l_{Ø} (28)

The constraints of Equation (29) define sets of potential values for decision variables. For example, the aₕ expression describes that the amount allocated to hybrid h must take on a non-negative, real, value (which may be fractional, etc.).

aₕ∈R₊∀h∈H, Iₕ^{ω}, z_{hgross}^{ω}, zₕₙₑₜ^{ω}∈R₊∀h∈H, ω∈Ω, x_{hh′gross}^{ω}, x_{hh′net}^{ω}, arpln_{hh′}^{ω}, artrn_{hh′}^{ω}∈R₊∀h, h′∈H, ω∈Ω, (29)

It should be appreciated that the above constraints may be imposed for allocating the production fields 108 in various combinations such that all or less than all of the constraints may be imposed. In addition, it should be appreciated that other constraints may be imposed to provide for accuracy, precision and/or completeness of a solution for allocating the production fields 108.

In addition to the constraints above, the engine 104 is further configured with an objective function (OF), as provided below, to be maximized for the associated scenarios and hybrids. In connection therewith, the last term in the objective function represents costs incurred when inventory is left over (see, e.g., Table 1 and Equation (25), etc.).

maximize Σ_{ω∈Ω}π_{ω}(Σ_{h,h′∈H}p_{hh′net}^{ω}−Σ_{h∈H}Oₕlₕ^{ω}) (OF)

The engine 104 may be configured to included further or other constraints, for example, as represented by Equations (30) and (31), whereby risk and total production are constrained. For example, with regard to statistical variance in profits, risk may be measured as the biggest difference in profits in two scenarios. As such, if scenario 1 has profits of 100, scenario 2 has profits of 90, and scenario 3 has profits of 120, then the risk is 120-90=30.

Δ_{Proffit}≤V_{Risk} (30)

T_{prod}≤V_{prod} (31)

Given the above, the engine 104 is configured to generate production target plans through an iterative process, as defined in Table 3. In particular, in this example embodiment, the engine 104 is configured to begin by solving the above constraints with sufficiently large values for Vᵣᵢₛₖ and V_{prod} so that the corresponding constraints are not binding, which generates a maximum expected profit, Z_{Profit}^{Max}, and the underlying plan for the production targets. It also yields the values Z_{Risk}^{Max} and Z_{Prod}^{Max}, which measure how that plan performs with respect to risk and total production when each is not the focus of solving the model 114. The engine 104 is configured to then iteratively solve the above for the production target plan with the values for Vᵣᵢₛₖ and V_{prod} being modified. For a given iteration t, the weight αₜ, where (0≤αₜ≤1), is where the value of Vᵣᵢₛₖ=(1−αₜ)*Z_{Risk}^{Max}. Similarly, the weight βₜ, where (0≤βₜ≤1), is where the value of V_{prod}=(1−βₜ)*Z_{Prod}^{Max}.

TABLE 3
Algorithm 1 ε-Constraint method

Require: T: maximum number of improvements for risk and production
target objectives.
Require: αₜ, t = 1,...,T: improvement percentages for risk objective.
Require: βₜ , t = 1,...,T: improvement percentages for production target
objective.

| | |
|---|---|
| 1: | Solve MO-SS-DSM with Vᵣᵢₛₖ = V_{prod} = ∞ to derive Z_{Profit}^{Max}, |
| | Z_{Risk}^{Max}, Z_{Prod}^{Max} |
| 2: | for t = 1,...,T do |
| 3: | Set Vᵣᵢₛₖ = (1 − αₜ) * Z_{Risk}^{Max} |
| 4: | for t = 1,...,T do |
| 5: | Set V_{prod} = (1 − βₜ) * Z_{Prod}^{Max} |
| 6: | Solve MO-SS-DSM to get Z_{Profit}^{αt βt} |
| 7: | end for |
| 8: | end for |

At this point, the model 114 indicates, for each hybrid, how much of the hybrid should be planted. The equations/constraints above, then, generally provide representations of rules that must be followed in connection with such planting amounts.

The engine 104 is configured, consistent with the above, to then store the production target plan for which profit is maximized in the context of a balanced risk and total production, in a memory (e.g., in the data structure 102, etc.). The engine 104 is further configured to generate instructions to execute or implement the production target plan on the production fields 108, through one or more farming implements and/or users associated therewith.

With the production target plan then executed, the system 100 proceeds (e.g., in conjunction with the producer 106, etc.) with the planting of the production fields 108, and then later harvest of the production fields 108, whereby an inventory of seeds is generated. At some point, the growers (including grower 112) begin to order seeds, whereby a demand for the seeds in the inventory becomes available. As different varieties of seeds are added to the inventory, for example, and as the demand is realized, data indicative of the same is included in the data structure 102.

The engine 104 is also capable of simulating the demand fulfillment performance of a given set of hybrid acreage allocations. To run the simulation, it is presumed that the planting decisions, as represented in the engine 104 by the decision variables, aₕ, have already been determined, and take on the values āₕ. To estimate the performance of these allocation amounts in a specific scenario w, the simulator solves an optimization problem, Sim(ā,w), that has the objective (OF) along with the constraints defined by Equation (4)-(29). Also defining this optimization problem are the constraints associated with Equation (32) that ensure the desired allocations are observed.

aₕ=āₕ (32)

The simulator executes by generating a set of scenarios over which the demand fulfillment performance of the allocation amounts āₕ will be evaluated (see, Table 4 below). It performs this evaluation by solving the optimization problem Sim(āₕ,w) and computing scenario-level performance measures such as net sales, lost net demand, and left-over inventory based on the solution to that optimization problem. These scenario-level statistics are then aggregated into expected performance measures that are computed over all scenarios.

TABLE 4
Algorithm 2 Demand Fulfillment Simulator

```
Require: Planting amounts āₕ, h ∈ H
  Generate set of scenarios Ω
  for ω ∈ Ω do
    Solve Sim(āₕ, ω)
    Collect demand fulfillment statistics (ne sales, left-over
    inventory, etc.)
  end for
  Report expected values of demand fulfillment statistics
```

In connection with the demand, the engine 104 is configured to determine a demand plan for the inventory of seeds (e.g., hybrids, etc.) to the growers to satisfy the demand. As noted above, the satisfaction of the demand may be based on the seeds ordered or requested (e.g., primary supply, etc.), or a substitute for the seeds as defined in the data structure 102. The engine 104 is configured, more specifically, to solve the objective function above, where Īₕ is the inventory of each seed, or in this example, hybrid h, as indicated in the data structure 102, as well as the net demand d̅ₕₙₑₜ and the gross demand d̅_{hgross} for each hybrid h.

In addition to the objective function (OF), the engine 104 is configured to rely on the constraints, as defined below via Equations (33) to (54), in maximizing the objective function, to generate a demand plan for supplying the inventory of seeds. It should be appreciated that the constraints below are similar to the constraints explained above.

$${\sum }_{{h}^{′} ∈ H : ( {h}^{′} , h ) ∈ S} {x}_{{h}^{′} hgross} \leq {\overline{d}}_{hgross} ∀ h ∈ H \qquad ( 33 )$$

$${\sum }_{{h}^{′} ∈ H : ( h , {h}^{′} ) ∈ S} {x}_{{hh}^{′} gross} \leq {\overline{I}}_{h} ∀ h ∈ H , \qquad ( 34 )$$

$${x}_{hhgross} \geq {\overline{d}}_{hgross} {η}_{h} ∀ h ∈ H , \qquad ( 35 )$$

$${x}_{hhgross} \geq {\overline{I}}_{h} - {M}_{h} {η}_{h} ∀ h ∈ H , \qquad ( 36 )$$

$${x}_{hhgross} \geq {\overline{I}}_{h} - ( 1 - {s}_{h} ) {M}_{h} ∀ h ∈ H , \qquad ( 37 )$$

$${x}_{{h}^{′} hgross} \leq {σ}_{{h}^{′} h} {\overline{d}}_{{hgross}^{S} h} ∀ ( {h}^{′} , h ) ∈ S , \qquad ( 38 )$$

$${arpln}_{{hh}^{′}} = {rpln}_{{hh}^{′}} {x}_{h {h}^{′} gross} ∀ ( h , {h}^{′} ) ∈ S , \qquad ( 39 )$$

$${artrn}_{{hh}^{′}} \geq adj - r t r {n}_{{h}^{′}} {x}_{h {h}^{′} gross} ∀ ( h , {h}^{′} ) ∈ S , \qquad ( 40 )$$

$${artrn}_{{hh}^{′}} \geq {rtrn}_{{h}^{′}} {x}_{h {h}^{′} gross} - {adj}_{h} {\overline{d}}_{{h}^{′} gross} ∀ ( h , {h}^{′} ) ∈ S , \qquad ( 41 )$$

$${\sum }_{h ∈ H} {adj}_{h} \leq {M}_{adj} , \qquad ( 42 )$$

$${x}_{{hh}^{′} net} = {x}_{h {h}^{′} gross} - {artrn}_{h {h}^{′}} - {arpln}_{h {h}^{′}} ∀ ( h , {h}^{′} ) ∈ S , \qquad ( 43 )$$

$${x}_{hhnet} + {z}_{hnet} = {\overline{d}}_{hnet} ∀ h ∈ H , \qquad ( 44 )$$

$${z}_{hgross} = \frac{{z}_{hnet}}{1 - {rpln}_{h} - {rtn}_{h}} ∀ h ∈ H , \qquad ( 45 )$$

$${z}_{hnet}^{sub} = {z}_{hnet} - {\sum }_{{h}^{′} ∈ H : ( {h}^{′} , h ) ∈ S , {h}^{′} \neq h} {x}_{{h}^{′} hnet} ∀ h ∈ H , \qquad ( 46 )$$

$${b}_{hgross}^{1} \leq {v}_{1} {\overline{d}}_{hgross} ∀ h ∈ H , \qquad ( 47 )$$

$${b}_{hgross}^{j} \leq {v}_{j} {\overline{d}}_{hgross} - {v}_{j - 1} {\overline{d}}_{hgross} ∀ h ∈ H , j = 2 , … , {v}_{{l}_{h}} \qquad ( 48 )$$

$${b}_{hgross}^{1} \leq {z}_{hgross} ∀ h ∈ H , \qquad ( 49 )$$

$${b}_{hgross}^{j} \leq {z}_{hgross} - {\sum }_{{j}^{′} = 1}^{j - 1} {b}_{hgross}^{{j}^{′}} ∀ h ∈ H , j = 2 , … , {v}_{{l}_{h}} \qquad ( 50 )$$

$$e {s}_{hgross} = {\sum }_{j = 1}^{{v}_{{l}_{h}}} {ε}_{{l}_{h}}^{j} {b}_{hgross}^{j} ∀ h ∈ H , \qquad ( 51 )$$

$${x}_{{h}^{′} hgross} \leq {σ}_{{h}^{′} h} e {s}_{hgross} ∀ ( {h}^{′} , h ) ∈ S , \qquad ( 52 )$$

$${\sum }_{{h}^{′} ∈ H : ( {h}^{′} , h ) ∈ S , {h}^{′} \neq h} {x}_{{h}^{′} hgross} \leq e {s}_{h g r o s s} ∀ h ∈ H , \qquad ( 53 )$$

$${l}_{h} = {\overline{I}}_{h} - {\sum }_{( h , {h}^{′} ) ∈ S} {x}_{{hh}^{′} gross} + {\sum }_{( h , {h}^{′} ) ∈ S} {artrn}_{{hh}^{′}} ∀ h ∈ H , \qquad ( 54 )$$

The engine 104 is configured, consistent with the above, to then store the demand or allocation plan for which profit is maximized, in memory (e.g., in data structure 102, etc.). The engine 104 is further configured to generate instructions to the producer 106 to satisfy demand consistent with the demand or allocation plan, whereby demand is satisfied by delivery of the seeds requested, or potentially, substitutes for the seed requested. The producer 106, in turn, executes the instruction to deliver the seeds consistent with the allocation plan. For instance, the producer 106 may be configured to compile, or package, the seeds in suitable containers consistent with the demand plan (e.g., with one or more containers including seed intended to be directed to particular growers, etc.) and then direct (e.g., route, transport, etc.) the seeds (e.g., via the containers, etc.) to the appropriate grower(s). As part of packaging the seeds, desired numbers and/or types (e.g., varieties, hybrids, etc.) of the seeds may be included in the containers, for example, as requested by the grower(s), etc. The grower(s) may then plant the seeds by directing planters, with the seeds, to appropriate growing spaces.

It should be appreciated that the allocation plan instruction may be delivered electronically, in one or more forms, such as, for example, via an interface of a website, network application, or through electronic messaging, such as email(s), etc.

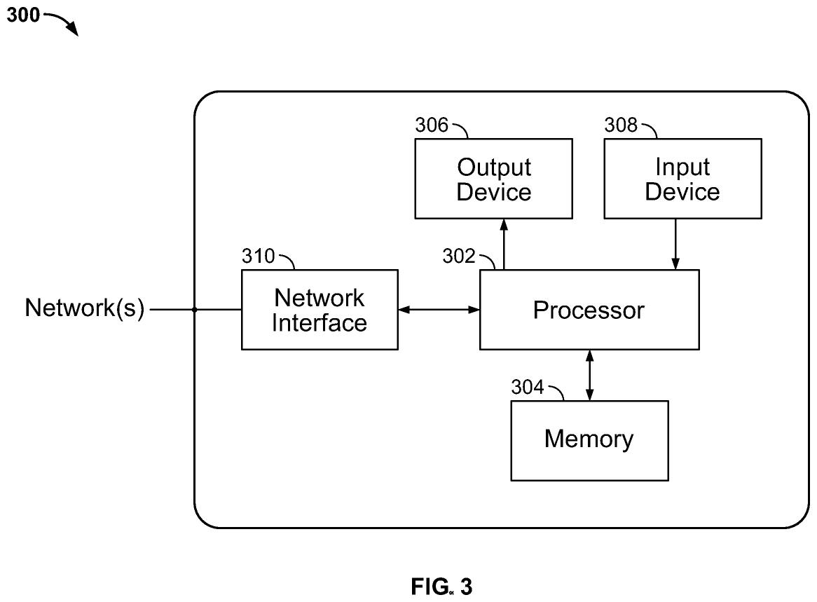

FIG. 3 illustrates an example computing device 300 that may be used in the system 100 of FIG. 1. The computing device 300 may include, for example, one or more servers, workstations, personal computers, laptops, tablets, smartphones, virtual devices, etc. In addition, the computing device 300 may include a single computing device, or it may include multiple computing devices located in close proximity or distributed over a geographic region, so long as the computing devices are specifically configured to operate as described herein. In the example embodiment of FIG. 1, the engine 104 includes and/or is implemented in one or more computing devices consistent with computing device 300. The data structure 102 may also be understood to include and/or be implemented in one or more computing devices, at least partially consistent with the computing device 300. However, the system 100 should not be considered to be limited to the computing device 300, as described below, as different computing devices and/or arrangements of computing devices may be used. In addition, different components and/or arrangements of components may be used in other computing devices.

As shown in FIG. 3, the example computing device 300 includes a processor 302 and a memory 304 coupled to (and in communication with) the processor 302. The processor 302 may include one or more processing units (e.g., in a multi-core configuration, etc.). For example, the processor 302 may include, without limitation, a central processing unit (CPU), a microcontroller, a reduced instruction set computer (RISC) processor, a graphics processing unit (GPU), an application specific integrated circuit (ASIC), a programmable logic device (PLD), a gate array, and/or any other circuit or processor capable of the functions described herein.

The memory 304, as described herein, is one or more devices that permit data, instructions, etc., to be stored therein and retrieved therefrom. In connection therewith, the memory 304 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media for storing such data, instructions, etc. In particular herein, the memory 304 is configured to store data including, without limitation, seed data, production field data, substitute indicators, historical demand data, historical yield data, cost data, profit data, return historical data, carry-in data, scenarios, model architectures, constraints, objective functions, and/or other types of data (and/or data structures) suitable for use as described herein.

Furthermore, in various embodiments, computer-executable instructions may be stored in the memory 304 for execution by the processor 302 to cause the processor 302 to perform one or more of the operations described herein (e.g., one or more of the operations of method 400, etc.) in connection with the various different parts of the system 100, such that the memory 304 is a physical, tangible, and non-transitory computer readable storage media. Such instructions often improve the efficiencies and/or performance of the processor 302 that is performing one or more of the various operations herein, whereby such performance may transform the computing device 300 into a special-purpose computing device. It should be appreciated that the memory 304 may include a variety of different memories, each implemented in connection with one or more of the functions or processes described herein.

In the example embodiment, the computing device 300 also includes an output device 306 that is coupled to (and is in communication with) the processor 302 (e.g., a presentation unit, etc.). The output device 306 may output information (e.g., schedules, production plants, allocation plans, etc.), visually or otherwise, to a user of the computing device 300, such as an operator, a researcher, a grower, etc. It should be further appreciated that various interfaces (e.g., as defined by network-based applications, websites, etc.) may be displayed or otherwise output at computing device 300, and in particular at output device 306, to display, present, etc. certain information to the user. The output device 306 may include, without limitation, a liquid crystal display (LCD), a light-emitting diode (LED) display, an organic LED (OLED) display, an “electronic ink” display, speakers, a printer, etc. In some embodiments, the output device 306 may include multiple devices. Additionally or alternatively, the output device 306 may include printing capability, enabling the computing device 300 to print text, images, and the like on paper and/or other similar media.

In addition, the computing device 300 includes an input device 308 that receives inputs from the user (i.e., user inputs) such as, for example, seed requests, inventory data, time/date data, etc. The input device 308 may include a single input device or multiple input devices. The input device 308 is coupled to (and is in communication with) the processor 302 and may include, for example, one or more of a keyboard, a pointing device, a touch sensitive panel, or other suitable user input devices. It should be appreciated that in at least one embodiment the input device 308 may be integrated and/or included with the output device 306 (e.g., a touchscreen display, etc.).

Further, the illustrated computing device 300 also includes a network interface 310 coupled to (and in communication with) the processor 302 and the memory 304. The network interface 310 may include, without limitation, a wired network adapter, a wireless network adapter, a mobile network adapter, or other device capable of communicating to one or more different networks (e.g., one or more of a local area network (LAN), a wide area network (WAN) (e.g., the Internet, etc.), a mobile network, a virtual network, and/or another suitable public and/or private network, etc.), for example, capable of supporting wired and/or wireless communication between the computing device 300 and other computing devices, including with other computing devices used as described herein (e.g., between the engine 104, the database 102, the producer 106, the grower 112, etc.).

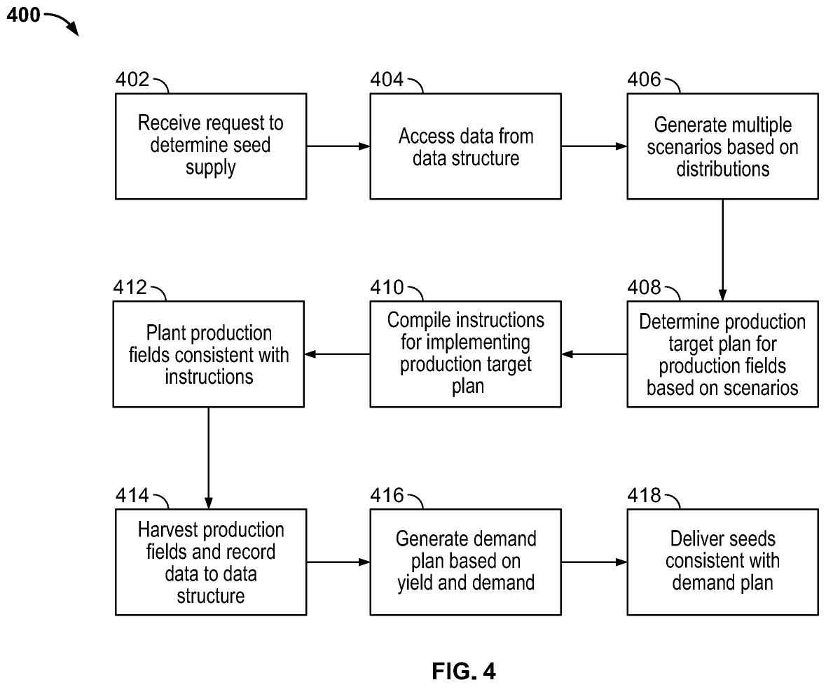

FIG. 4 illustrates an example method 400 for assessing seed production and seed inventories. The example method 400 is described herein in connection with the system 100, and may be implemented, in whole or in part, in the engine 104 of the system 100. Further, for purposes of illustration, the example method 400 is also described with reference to the computing device 300 of FIG. 3. However, it should be appreciated that the method 400, or other methods described herein, are not limited to the system 100 or the computing device 300. And, conversely, the systems, data structures, and the computing devices described herein are not limited to the example method 400.

At the outset, it should be appreciated that the data structure 102 includes data relevant to the production fields 108, the seed offering from the producer 106, and historical distributions of demand, yield and also carry-in inventory 110.

With that said, at 402, a user may desire to determine seed supply for a following year by submitting, for example, a request to the engine 104. In doing so, the timing of the determination and/or corresponding assessment may be relative to planting of the production fields 108 (and/or other fields), planning for inventory (e.g., by the producer 106, etc.), allocation of resources by users in the system 100 (e.g., planters, combines, other resources, etc.), etc. Additionally, as generally described herein, the timing of the determination may dictate the information available for use in the underlying assessment whereby, for example, certain timings for initiating the method 400 may be preferred over others.

In response, the engine 104 accesses, at 404, data included in the data structure 102. As indicated above, the data includes details related to the production fields 108, including, without limitation, capacity, acres, location, cost associated with planting the fields, crop type information, etc., and also details related to the seed offerings of the producer 106 including, without limitation, a listing of seeds (e.g., hybrids, etc.) (e.g., by name, identifier, features, etc.), cost and profit for the seeds, indicators of substitutions (and non-substitutions) of seeds, etc.

The accessed data, included in the data structure 102, may further include data representative of (or indicative of or used to generate, etc.) multiple distributions for the different seeds (or different seed varieties, etc.), whereby the distributions are determined by the engine 104 in the context of the method 300 or apart therefrom. The engine 104 may then determine from the accessed data relative to the distributions, for example, yield distributions, demand distributions and carry-in distributions. The yield distribution for a given seed indicates a range of yields for the seed and associated probabilities of the yields, based on historical data for the seed. Similarly, the demand distribution includes a range of demands for the seed and associated probabilities of the demands, based on historical data for the demand of the seed. The carry-in inventory distribution is similar as well. It should be appreciated that the distributions may be determined here, or separately and then stored and accessed by the engine 104 in the method 300.

At 406, and based on the distributions, the engine 104 generates different scenarios for the yield, the demand, and the carry-in inventory, of each seed (e.g., each variety of seed, etc.) in the seed offering for the producer 106. The scenarios indicate, for example, a specific yield, a specific demand, and a carry-in inventory for a variety of seed. The engine 104 may generate dozens or hundreds or thousands of different scenarios (e.g., 100 scenarios, 200 scenarios, 300 scenarios, etc.). In general, the scenarios are potential values of the yield and demand (and carry-in inventory) (e.g., potentially limited (or selected) based on probability distributions, etc.) for the seeds in the seed offering from the producer 106. The scenarios are an input to the constraints and/or objective function above, and designated, for example, at Ω.

The engine 104 then determines, at 408, a production target plan for the production fields 108, based on the scenarios. In particular, the engine 104 solves (e.g., optimizes, etc.) the objective function above, to define a specific production target plan, which maximizes profits, and further balances risk and total production, across the different scenarios. In doing so, the engine 104 may indicate how much inventory to establish for each variety of seed, and how much of each variety of seed should be planted. In some examples, the production target plan may also include a designation of the different production fields 108 along with an indication of the seeds, from the seed offering of the producer 106, to be planted in the production fields 108.

At 410, the engine 104 compiles instructions for implementing the production target plan, which includes, for example, designations of the fields 108 and the seed(s) to be planted therein. In doing so, the engine 104 may resolve the production target plan into actual crop planning for the production fields 108 (e.g., for determining how much inventory to establish for each variety of seed and, in connection therewith, and how much of each variety of seed to plant, etc.). Additionally, or alternatively, the production target plan may be used as an input or guide to such crop planning and for allocating resources to achieve the same (e.g., allocating growing spaces for planting, allocating equipment to growing spaces, etc.).

The instructions are passed to the fields 108 and farm implements therein (e.g., planters, etc.), whereby, at 412, the producer 106 plants the production fields 108 consistent with the instructions. For instance, planters may be loaded with desired seed, based on the instructions, and then operated to traverse the fields 108 to plant the seed. In doing so, the seed is generally planted in rows within the fields 108 at desired row spacings and at desired seed spacings within the rows. The plants are permitted to grow in the production fields 108 and, potentially, are subject to one or more treatments, as required or desired to protect the crops, enhance yield, etc.

At 414, then, once the plants in the production fields 108 have reached an appropriate growth stage, moisture content, etc., the production fields 108 are harvested by the producer 106. For instance, this may include operating pickers, combines, other harvesting equipment in the fields to collect the plants, and then processing the collected plants to remove the seeds therefrom. In connection therewith, data indicative of the yield of the production fields 108 is reported to the engine 104, and the engine 104 records the data in the data structure 102. In connection therewith, the producer 106 builds the inventory of the different seeds from the seed offering of the producer 106. At this time, or around this time, or later, the grower 112, for example, and other growers, begin to submit orders for seeds, which are indicative of demand for the seeds. The demand may be received over an interval of weeks, or months, etc. Like the data indicative of the yield, data indicative of demand is also recorded to the data structure 102.

At 416, in response to the demand, and the yield from the production fields 108, the engine 104 generates a demand plan, taking into account the yield of the seeds and the demand, based on the objective function above, to maximize profit for supplying the seeds consistent with the demand. As explained above, the demand plan may include providing requested seeds (e.g., a specific variety, etc.), or substitutes for requested seeds (as indicated in the data structure 102, etc.).

Finally, at 418, the producer 106 delivers the seeds consistent with the demand plan, whereby seeds are received by the growers and planted or otherwise used as appropriate by or for the growers. This may include compiling, or packaging, seeds in suitable containers consistent with the demand plan (e.g., with one or more containers including seed intended to be directed to particular growers, etc.) and then directing (e.g., routing, transporting, etc.) the seeds (e.g., via the containers, etc.) to the grower(s). As part of packaging the seeds, desired numbers and/or types (e.g., varieties, hybrids, etc.) of the seeds may be included in the containers, for example, as requested by the grower(s), etc. The grower(s) may then plant the seeds by directing planters, with the seeds, to appropriate growing spaces.

In view of the above, the systems and methods herein provide for decisions regarding how much inventory to hold of different varieties of seeds to be made in advance of availability of complete information regarding supply and market conditions. For instance, hybrid production targets may be determined in advance of complete information regarding both supply and demand attributes. Regarding supply, however, the targets are often determined prior to information being available as to how much leftover inventory from the previous year is sellable/available. The targets may also be determined without knowing the yield for the amount of seeds planted of each hybrid. And, regarding demand, the targets may be determined in advance of available data for customer demands for hybrids. The engine (e.g., simulation tool, etc.) described herein provides a predictive analytics tool configured to determine how well a set of planned hybrid production targets will meet market demand. In doing so, the engine recognizes that hybrid product substitution may occur, and thus prescribes demand fulfillment decisions.

With that said, it should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure may transform a general-purpose computing device into a special-purpose computing device when configured to perform one or more of the functions, methods, and/or processes described herein.

As will be appreciated based on the foregoing specification, the above-described embodiments of the disclosure may be implemented using computer programming or engineering techniques, including computer software, firmware, hardware or any combination or subset thereof, wherein the technical effect may be achieved by performing at least one of the following operations: (a) accessing data representative of: a seed offering including multiple different seeds, a capacity of multiple production fields, and probability distributions for yield across the multiple fields and for demand for the multiple different seeds; (b) generating a production target plan, based on multiple scenarios indicative of the probability distributions, for the multiple different seeds and for the production fields; (c) generating the multiple scenarios, each of the scenarios including a yield of the production fields and a demand for each of the multiple different seeds; and (d) directing planting of the multiple production fields consistent with the production target plan.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above-mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in assessing variables associated with seed production, the method comprising:
accessing, by a computing device, data representative of: a seed offering including multiple different seeds, a capacity of multiple production fields, and probability distributions for yield across the multiple fields and for demand for the multiple different seeds;
generating, by the computing device, a production target plan, based on multiple scenarios indicative of the probability distributions, for the multiple different seeds and for the production fields; and
planting the multiple production fields consistent with the production target plan.

2. The computer-implemented method of claim 1, further comprising generating, by the computing device, the multiple scenarios, each of the scenarios including a yield of the production fields and a demand for each of the multiple different seeds.

3. The computer-implemented method of claim 1, wherein the data further includes substitution indicators for ones of the multiple different seeds; and
wherein generating the production target plan includes generating the production target plan based on a demand for one of the multiple seeds being at least partially fulfilled by a different one of the multiple seeds having a substitute indicator for the one of the multiple seeds.

4. The computer-implemented method of claim 1, wherein generating the production target plan is further based on:
$$maximize {\sum }_{ω ∈ Ω} {π}_{ω} ( {\sum }_{h , {h}^{′} ∈ H} {p}_{{hh}^{′}} {x}_{{hh}^{′} net}^{ω} - {\sum }_{h ∈ H} {o}_{h} {l}_{h}^{ω} ) .$$

5. The computer-implemented method of claim 1, wherein the probability distributions include one or more yield distributions, one or more carry-in distributions, and one or more demand distributions.

6. The computer-implemented method of claim 1, further comprising generating, by the computing device, a demand plan based on demand for each of the multiple different seeds.

7. The computer-implemented method of claim 6, further comprising delivering seeds to one or more growers consistent with the demand plan.

8. The computer-implemented method of claim 6, further comprising packaging seeds consistent with the demand plan.

9. The computer-implemented method of claim 8, further comprising directing seeds to particular containers based on the demand plan, for delivery to growers.

10. A non-transitory computer-readable storage medium including executable instructions, which when executed by at least one processor, cause the at least one processor to:
access data representative of: a seed offering including multiple different seeds, a capacity of multiple production fields, and probability distributions for yield across the multiple fields and for demand for the multiple different seeds;
generate a production target plan, based on multiple scenarios indicative of the probability distributions, for the multiple different seeds and for the production fields; and
transmit the production target plan to one or more farm implements, whereby the one or more farm implements plant the multiple production fields consistent with the production target plan.

11. The non-transitory computer-readable storage medium of claim 10, wherein the executable instructions, when executed by the at least one processor, further cause the at least one processor to generate the multiple scenarios, each of the scenarios including a yield of the production fields and a demand for each of the multiple different seeds.

12. The non-transitory computer-readable storage medium of claim 11, wherein the data further includes substitution indicators for ones of the multiple different seeds; and
wherein the executable instructions, when executed by the at least one processor to generate the production target plan, cause the at least one processor to generate the production target plan based on a demand for one of the multiple seeds being at least partially fulfilled by a different one of the multiple seeds having a substitute indicator for the one of the multiple seeds.

13. The non-transitory computer-readable storage medium of claim 10, wherein the executable instructions, when executed by the at least one processor to generate the production target plan, cause the at least one processor to generate the production target plan further based on:
$$maximize {\sum }_{ω ∈ Ω} {π}_{ω} ( {\sum }_{h , {h}^{′} ∈ H} {p}_{{hh}^{′}} {x}_{{hh}^{′} net}^{ω} - {\sum }_{h ∈ H} {o}_{h} {l}_{h}^{ω} ) .$$

14. The non-transitory computer-readable storage medium of claim 13, wherein the executable instructions, when executed by the at least one processor, further cause the at least one processor to generate a demand plan based on demand for each of the multiple different seeds.

15. A system for use in assessing variables associated with seed production, the system comprising a computing device configured to:
access data representative of: a seed offering including multiple different seeds, a capacity of multiple production fields, and probability distributions for yield across the multiple fields and for demand for the multiple different seeds; and
generate a production target plan, based on multiple scenarios indicative of the probability distributions, for the multiple different seeds and for the production fields.

16. The system of claim 15, wherein the computing device is further configured to direct one or more farm implements to plant the multiple production fields consistent with the production target plan.

17. The system of claim 16, wherein the computing device is further configured to generate the multiple scenarios, each of the scenarios including a yield of the production fields and a demand for each of the multiple different seeds.

18. The system of claim 16, wherein the data further includes substitution indicators for ones of the multiple different seeds; and
wherein the computing device is configured, in order to generate the production target plan, to generate the production target plan based on a demand for one of the multiple seeds being at least partially fulfilled by a different one of the multiple seeds having a substitute indicator for the one of the multiple seeds.

19. The system of claim 15, wherein the computing device is configured to generate the production target plan further based on:
$$maximize {\sum }_{ω ∈ Ω} {π}_{ω} ( {\sum }_{h , {h}^{′} ∈ H} {p}_{{hh}^{′}} {x}_{{hh}^{′} net}^{ω} - {\sum }_{h ∈ H} {o}_{h} {l}_{h}^{ω} ) .$$

20. The system of claim 19, wherein the probability distributions include one or more yield distributions, one or more carry-in distributions, and one or more demand distributions.
